(19) United States
(12) Patent Application Publication
(10) Pub. No.: US 2019/0007229 A1
(43) Pub. Date: Jan. 3, 2019

(54) DEVICE AND METHOD FOR CONTROLLING ELECTRICAL APPLIANCES

(71) Applicant: BOE TECHNOLOGY GROUP CO., LTD., Beijing (CN)

(72) Inventor: Ran DUAN, Beijing (CN)

(21) Appl. No.: 15/945,031

(22) Filed: Apr. 4, 2018

(30) Foreign Application Priority Data
Jun. 30, 2017 (CN) 201710526955.4

(51) Int. Cl. H04L 12/28; G08C 17/02; G06F 3/01; G06F 3/042; G06F 3/0484; G05B 15/02

(52) U.S. Cl. CPC H04L 12/282; G08C 17/02; G06F 3/017; G06F 3/0426; H04L 2012/285; G05B 15/02; G08C 2201/30; G08C 2201/70; H04L 2012/2841; G06F 3/0484

(57) ABSTRACT

A device for controlling electrical appliances is described, which includes a projector configured to project a graphical interface having a plurality of image areas representing different electrical appliances respectively; a camera configured to obtain a first image including an operation action of a user on the graphical interface; and a controller configured to determine a target image area and a control instruction corresponding to the operation action according to said first image and to send said control instruction to an electrical appliance corresponding to the target image area.

### RELATED APPLICATIONS

The present application claims the benefit of Chinese Patent Application No. 201710526955.4, filed on Jun. 30, 2017, the entire disclosure of which is incorporated herein by reference.

### TECHNICAL FIELD

The present disclosure relates to the field of electric control, in particular to a device and method for controlling a plurality of electrical appliances.

### BACKGROUND

Some fixed switches usually need to be arranged in rooms for power switching of electrical appliances like lights, air conditioners, etc. in daily life. However, such kind of switches cannot have their positions changed once being arranged, which is inconvenient for users. Besides, if the number of electrical appliances is to be increased, more fixed switched will have to be arranged, which usually requires making big changes to the rooms, such as reconstructing the circuits in the rooms, and will be very tedious.

### SUMMARY

In view of the above, the present disclosure provides a device and a method for controlling electrical appliances.

According to an aspect of the present disclosure, a device for controlling electrical appliances is provided, which comprises: a projector configured to project a graphical interface having a plurality of image areas representing different electrical appliances respectively; a camera configured to obtain a first image including an operation action of a user on the graphical interface; and a controller configured to determine a target image area and a control instruction corresponding to the operation action according to said first image and to send said control instruction to an electrical appliance corresponding to the target image area.

In certain exemplary embodiments, the controller is further configured to obtain state information of the plurality of electrical appliances to be controlled and to generate the graphical interface according to the obtained state information, wherein each of the plurality of image areas displays the state information of the corresponding electrical appliance.

In certain exemplary embodiments, the controller is further configured to, after sending said control instruction to the electrical appliance corresponding to the target image area, obtain an altered operation state of said electrical appliance and update the state information of said electrical appliance in the graphical interface.

In certain exemplary embodiments, the device further comprises a housing configured to accommodate the projector, the camera, and the controller.

In certain exemplary embodiments, the device further comprises a wireless transceiver disposed within the housing and configured to establish communication between the controller and the electrical appliance.

In certain exemplary embodiments, the device further comprises a power interface through which the device is supplied with power.

In certain exemplary embodiments, the device further comprises a power manager configured to manage the supply of power.

In certain exemplary embodiments, the controller is further configured to obtain characteristic information of each node of a hand of the user in the first image and determine an image area where a predetermined node of the user is located as the target image area.

According to another aspect of the present disclosure, a method for controlling electrical appliances is provided, which comprises: projecting and displaying a graphical interface having a plurality of image areas representing different electrical appliances; obtaining a first image including an operation action of a user on the graphical interface; determining a target image area and a control instruction corresponding to the operation action according to said first image; sending said control to instruction to an electrical appliance corresponding to the target image area.

In certain exemplary embodiments, the operation action comprises at least one of a touch operation action and a non-touch operation action.

In certain exemplary embodiments, determining the target image area corresponding to the operation action according to the first image comprises: obtaining characteristic information of each node of a hand of the user in the first image and determining an image area where a predetermined node of the user is located as the target image area.

In certain exemplary embodiments, said method further comprises pre-identifying nodes of a gesture corresponding to each control instruction from a plurality of predetermined control instructions and storing the identified nodes as a hand skeleton model associated with said control instruction so as to form a plurality of hand skeleton models; determining a control instruction corresponding to the operation action according to the first image and the plurality of hand skeleton models stored.

In certain exemplary embodiments, determining the control instruction corresponding to the operation action according to the first image and the plurality of hand skeleton models stored comprises: obtaining characteristic information of each node of a hand of the user in the first image and creating a current hand skeleton model according to the obtained characteristic information of each node; matching said current hand skeleton model with the stored plurality of hand skeleton models; in response to a difference between the current hand skeleton model and one of the stored plurality of hand skeleton models falling within a threshold range, determining the control instruction associated with said one hand skeleton model as the control instruction corresponding to the operation action.

In certain exemplary embodiments, projecting and displaying a graphical interface having a plurality of image areas representing different electrical appliances comprises: obtaining state information of the plurality of electrical appliances to be controlled; generating a graphical interface having a plurality of image areas representing different electrical appliances, wherein each of the plurality of image areas displays the state information of the corresponding electrical appliance; and projecting and displaying the graphical interface.

In certain exemplary embodiments, the method further comprises: after sending the control instruction to the electrical appliance corresponding to the target image area, obtaining an altered operation state of the electrical appliance and updating the state information of said electrical appliance in the graphical interface.

### BRIEF DESCRIPTION OF THE DRAWINGS

The drawings are provided to facilitate further understanding of the present disclosure and form a part of the description, but they do not intend to limit the present disclosure. In the drawings:

FIG. 1 is a schematic structural block diagram of a device for controlling electrical appliances according to an embodiment of the present disclosure;

FIG. 2 is schematic drawing of a use state of the device for controlling electrical appliances according to an embodiment of the present disclosure;

FIG. 3 is schematic drawing of a graphical interface projected by the device for controlling electrical appliances in an embodiment of the present disclosure;

FIG. 4 is a flow chart of a method for controlling electrical appliances according to an embodiment of the present disclosure;

FIG. 5 is a schematic drawing of identifying nodes of a gesture operation in the method for controlling electrical appliances according to another embodiment of the present disclosure.

### DETAILED DESCRIPTION

The reference signs are listed as follows: 1—projector; 2—camera; 3—housing; 4—sucker; 5—controller; 6—power interface and/or external battery; 7—wireless transceiver; 8—power manager; 9—graphical interface; 10—image area.

Detailed descriptions of the present disclosure will be given below with reference to the drawings.

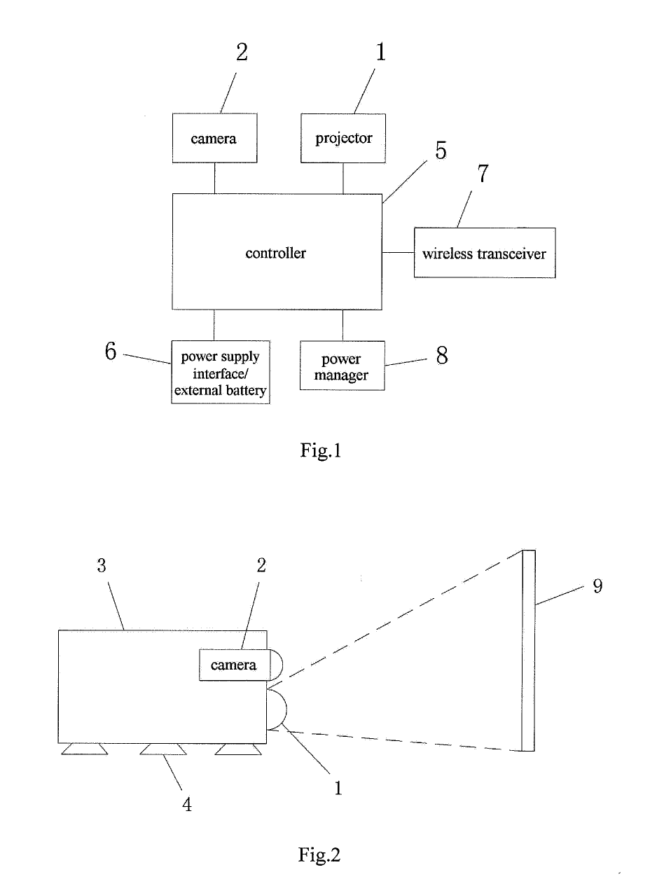

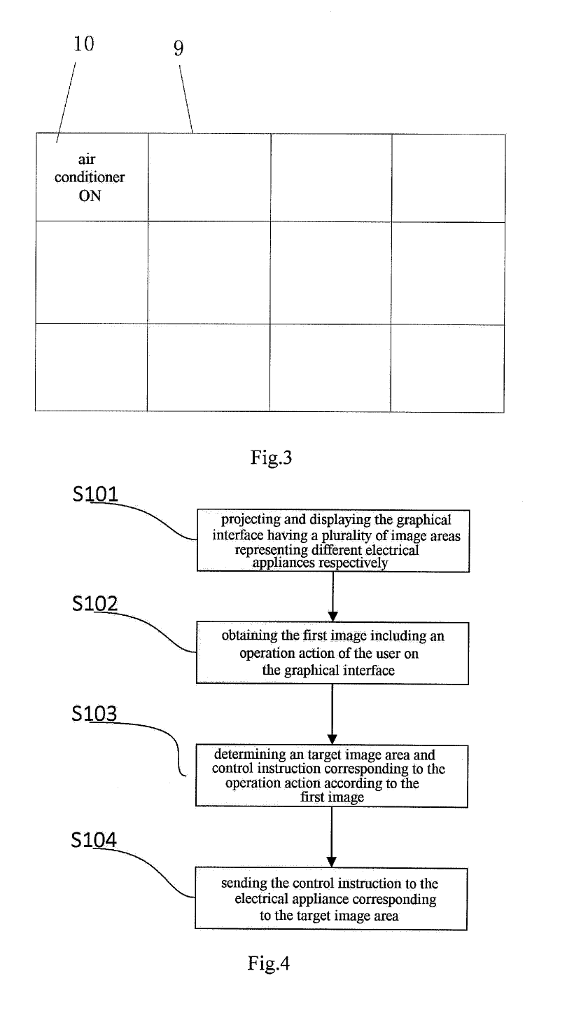

FIG. 1 is a schematic structural block diagram of a device for controlling electrical appliances according to an embodiment of the present disclosure; FIG. 2 is schematic drawing of a use state of the device for controlling electrical appliances according to an embodiment of the present disclosure; FIG. 3 is schematic drawing of a graphical interface projected by the device for controlling electrical appliances in an embodiment of the present disclosure. As shown in FIGS. 1-3, the device may comprise a projector 1, a camera 2 and a controller 5.

The projector 1 is configured to project a graphical interface 9 having a plurality of image areas 10 representing different electrical appliances.

The user can make operation actions on the graphical interface 9, which, for example, can be realized by touching or blocking an arbitrary or a predetermined position in a certain image area 10 by a finger of the user, touching or blocking an arbitrary or a predetermined position in a certain image area 10 by other objects, the user making a certain operation gesture in an area of a certain image area 10, or the user using a laser pen to point at an arbitrary or a predetermined position in a certain image area 10, and so on.

The camera 2 is configured to obtain a first image including an operation action of a user on the graphical interface 9. Depending on the different operation actions made by the user on the image area 10, the first image may, for example, include operation gestures or blocking or touch operation actions, etc. made on the image area.

The controller 5 is configured to analyze the first image so as to determine a target image area corresponding to the user's operation action and a control instruction corresponding to the user's operation action, and to send the determined control instruction to an electrical appliance corresponding to the target image area. The control instruction can be an instruction for enabling the user to control the state of the electrical appliance, for example, an instruction for turning on an electrical appliance, turning off an electrical appliance, adjusting a continuous operating time of an electrical appliance, setting a delayed turning off time of an electrical appliance, etc. The controller may be a device having computing and processing capabilities, such as a central processing unit (CPU), a programmable logic device, and the like.

In the embodiment of the present disclosure, the projector 1, camera 2 and controller 5 of the device can be accommodated in a housing 3. A plurality of fixed components, e.g. suckers 4, adhesive pieces, etc., can be arranged on a bottom or a side of the housing 3. The user can detachably fix the device for controlling electrical appliances on the floor, table or wall of any room through a fixing component like the sucker 4, so it is flexible to use. For example, FIG. 2 shows a usage scenario of fixedly arranging the device for controlling electrical appliances on the table or floor, wherein the projector 1 projects the graphical interface 9 on the wall. When the device is fixedly arranged on the wall, the projector 1 can project the graphical interface 9 on the wall, table or floor in a projection direction of the projector 1.

As shown in FIG. 1, the device for controlling electrical appliances in the embodiment of the present disclosure may further comprise an external battery and/or power supply interface 6, and a power manager 8 for managing power supply of the above-mentioned electrical components in the device through the external battery and/or power supply interface. In addition, the device may also include a memory (not shown) for storing data, which may also be integrated with the controller.

In an embodiment of the present disclosure, as shown in FIG. 1, the housing 3 may have a wireless transceiver 7 disposed therein, which is configured to establish communication between the controller 5 and the electrical appliance. For example, the controller 5 sends the control instruction to the electrical appliance through the wireless transceiver 7 and the controller 5 can obtain state information of the plurality of electrical appliances to be controlled through the wireless transceiver 7. The controller 5 can generate a graphical interface to be projected according to the obtained state information, so that state information of each of the electrical appliances is displayed in an image area corresponding to said each electrical appliance in said graphical interface, which indicates the current operation state of said each electrical appliance. Thus the user can directly see the current operation state of each electrical appliance so as to operate some of the electrical appliances as desired to change the operation state thereof.

In another embodiment of the present disclosure, the controller 5 can also be configured to, after sending the control instruction to the electrical appliance corresponding to the target image area, obtain an altered operation state of said electrical appliance through the wireless transceiver 7 and update the state information in the image area corresponding to said electrical appliance in the graphical interface to be projected according to the altered operation state of said electrical appliance. In the embodiment of the present disclosure, after making an operation action in the target image area, the user can directly see in real time the operation state change of the electrical appliance after executing the control instruction corresponding to the operation action.

In an embodiment of the present disclosure, the user can configure parameters of the device for controlling electrical appliances through a mobile phone or a personal computer (PC). The user can establish a communication connection between the mobile phone or PC and the device for controlling electrical appliances and then configure the device for controlling electrical appliances on the mobile phone or the PC. For example, configurations made by the user to the device for controlling electrical appliances may include: adjusting sizes or number of image areas 10 included in the graphical interface 9 projected by the projector 1, specifying which image area 10 corresponds to which electrical appliance, displaying the state information of the electrical appliances in the image areas or not, and so on. In addition, auxiliary information of the electrical appliances can be configured in the image areas 10, such as the time for which the electrical appliances are continuously used, or a timing interface can be configured so as to turn on and off the electrical appliances at predetermined times.

In another embodiment of the present disclosure, the projector 1 can also project a configuration interface that is to be operated by the user. The camera 2 obtains an image including a configuration operation action of the user, and then the controller 5 identifies configuration instruction corresponding to the operation action from the obtained image and correspondingly updates the projection interface. For example, when the user needs to adjust the size of the image area 10 in the graphical interface 9, he/she may draw the boundaries of the desired area by a finger in the graphical interface 9, and the controller 5 can identify said boundaries as boundaries of the image area 10 that is to be set; when the user needs to set the electrical appliance corresponding to a certain image area 10, he/she may draw a predetermined pattern in said image area 10 by a finger, such as a triangle, a quadrilateral, a hexagram, etc., then the controller 5 can determine the electrical appliance corresponding to said image area 10 according to the electrical appliance corresponding to the predetermined pattern.

After finishing configuring the device for controlling electrical appliances, the device and the appliances that are to be controlled are connected to a local area network. The device for controlling electrical appliances can be fixedly arranged by the user at a target location as desired so as to be used. The device for controlling electrical appliances will project, in a configured mode, the graphical interface showing the names and state information of the electrical appliances, and the user can operate on the projected graphical interface so as to operate the target electrical appliances.

FIG. 4 is a flow chart of a method for controlling electrical appliances according to an embodiment of the present disclosure. As shown in FIG. 4, the method for controlling electrical appliances according to an embodiment of the present disclosure comprises steps S101-S104.

In step S101, the graphical interface is projected and displayed, and said graphical interface has a plurality of image areas representing different electrical appliances respectively.

For example, when the electrical appliances to be controlled include a light, a TV, an air conditioner and a fan, the graphical interface may include four image areas corresponding to the light, the TV, the air conditioner and the fan, respectively. When the electrical appliances to be controlled include a light, a fridge, an air conditioner, a humidifier, an air conditioner and a fan, the graphical interface may include six image areas corresponding to the light, the fridge, the air conditioner, the humidifier, the air conditioner and the fan, respectively. The embodiment of the present disclosure does not limit the number of image areas in the graphical interface, and according to the number of electrical appliances to be controlled, the graphical interface may include image areas of the corresponding number.

In step S102, the first image including the operation action of the user on the graphical interface is obtained.

The user can make an operation action on the projected graphical interface. For example, the user touches or blocks an arbitrary position or a predetermined position of a certain image area with a finger, the user touches or blocks an arbitrary position or a predetermined position of a certain image area with other objects, the user makes a certain operation gesture in an area of a certain image area, the user pointing at an arbitrary position or a predetermined position of a certain image area with a laser pen, etc. The operation action of touching the image area with a finger, a knuckle or other objects can be called a touch operation action, and the operation action that does not touch the image area, such as blocking the image area, making a gesture in the image area, pointing at the image area with pointers like a laser pen, etc., can be called a non-touch operation action.

In the embodiments of the present disclosure, the projected graphical interface can be imaged at predetermined time intervals. When the imaged graphical interface includes the user's operation action on the graphical interface, the obtained graphical interface is determined as the first image.

In step S103, the target image area and control instruction corresponding to the operation action is determined according to the first image.

By analyzing the first image, the image area at which the user's hand or the object manipulated by the user points in the first image can be determined. In an embodiment of the present disclosure, the operation action can be identified in various ways. For example, a gray image with respect to the first image can be calculated so as to determine whether the gray image includes a predetermined shape of the finger and to which image area the predetermined shape of the finger corresponds, thereby determining the area at which the finger actually points. The predetermined shape of the finger can be determined as corresponding to a predetermined control instruction in advance. The predetermined shape of the finger may be, for example, the index finger being straightened or bent, the finger pad or finger nail facing upward, the index finger and the middle finger being closed together, etc.

In the embodiment of the present disclosure, when the user's hand makes an operation action, it can be determined whether said operation action is a touch operation action or not by determining whether the user's finger deforms when it touches the wall or floor on which the graphical interface is projected. For example, deformation characteristics of the finger pad or finger contour are learned by means of a deep learning method, and it is determined whether a touch exists according to whether the finger has deformation characteristics or not when analyzing the first image, and the target image area corresponding to the operation action is determined according to the area where the touch point is located.

In another embodiment of the present disclosure, for example, according to the consecutively obtained multiple first images, a time for which a predetermined part of the user's finger or a predetermined part of a manipulated object (e.g. a fingertip or a front end of the manipulated object) remains in a certain area in the graphical interface can be determined. If the time exceeds a preset time threshold (e.g. 3 seconds or 5 seconds), it is determined that the image area where said predetermined part of the user's finger or the manipulated object is located is the target image area, and the control instruction corresponding to the operation action is determined at the same time, which, for example, changes a current ON/OFF state of the electrical appliance corresponding to the target image area into an OFF/ON state.

In still another embodiment of the present disclosure, a distance between the user's finger and the camera for obtaining the first image can be measured. Said camera can be a binocular camera. For example, when the fingertip of the index finger touches the target image area, a distance between the projected interface and the binocular camera can be measured in advance, then after obtaining the first image, it can be calculated whether the distance between the binocular camera and the finger is greater than a preset threshold. If the distance between the binocular camera and the finger is greater than a preset threshold, it can be determined that the finger operation is, for example, a control instruction of turning on the electrical appliance (or turning off the electrical appliance).

In step S104, the control instruction is sent to the electrical appliance corresponding to the target image area.

After determining the target image area and control instruction corresponding to the operation action, the determined control instruction can be sent to the electrical appliance corresponding to the determined target image area, thereby operating the electrical appliance through operating on the projected graphical interface by the user.

By means of the method for controlling electrical appliances as provided in the embodiment of the present disclosure, the graphical interface can be projected which includes different image areas showing state information of each of the electrical appliances to be controlled. The user can perform operation actions in the target area to control and operate the target electrical appliance without the need to control and operate the electrical appliance through a physical switch, thus the operation becomes more direct, convenient, intelligent, humanized and flexible.

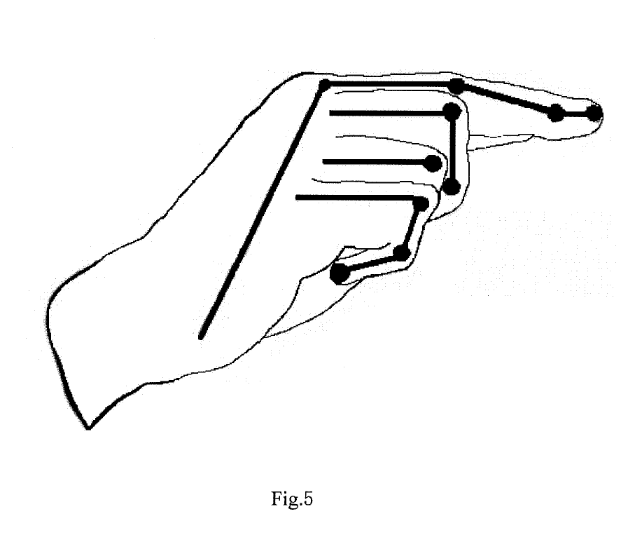

FIG. 5 is a schematic drawing of identifying nodes of a gesture operation in the method for controlling electrical appliances according to another embodiment of the present disclosure.

As shown in FIG. 5, in an embodiment of the present disclosure, when determining the target area corresponding to the operation action, the first image may be analyzed to obtain characteristic information (e.g. position information) of each node of the user's hand, and the image area where a predetermined node of the user's hand is located is determined as the target image area. For example, when a required operation action is touching or blocking by a fingertip, the index fingertip node is determined from each of the identified nodes, and the image area where the index fingertip node is located is determined as the target image area. As another example, when a required operation action is making a fist, finger knuckle nodes are determined from each of the identified nodes, and the area where most or all of the knuckle nodes are located is determined as the target image area.

In another embodiment of the present disclosure, the user may be trained to learn a plurality of particular gestures in advance, such as spreading five fingers, making a fist, stretching out the index finger or thumb when making a fist, etc., and the angles of the gestures may be specified in advance to facilitate identification, for example, the direction pointed at by the finger is parallel or perpendicular to the projection direction.

In the embodiment of the present disclosure, in order to reduce the user's burden and to spare the memorizing of the gesture directions, various gestures that might be used by the user can be entered into a control system in advance by means of the deep learning method for training and learning, and the predetermined control instructions and the learned corresponding gestures are associated and stored, so that the control system can directly identify the gesture operation made by the user upon obtaining the first image and obtain the control instruction associated with the gesture operation.

In yet another embodiment of the present disclosure, nodes of a plurality of different gesture actions corresponding to the respective predetermined control instructions can be identified in advance so as to generate a plurality of corresponding predetermined hand skeleton models and to associate them with the corresponding predetermined control instructions. After obtaining the first image, the gesture operation action in the first image may be matched to the stored predetermined hand skeleton models so as to determine the control instruction corresponding to the operation action. Said predetermined control instructions and predetermined hand skeleton models can be stored in a database, so that each kind of gesture has a control instruction corresponding thereto. In order to spare the user from memorizing the gesture angles, the same gesture can be made in a plurality of different angles in advance, and a plurality of hand skeleton models corresponding to the same gesture operation can be generated.

In an embodiment of the present disclosure, after obtaining the first image, characteristic information of each node of the user's hand can be obtained from the first image, and then a current hand skeleton framework is constructed according to the obtained characteristic information. The current hand skeleton model can be compared and matched with the pre-stored predetermined hand skeleton models one by one. The pre-stored hand skeleton models cannot include all the gesture angles, and even if the predetermined hand skeleton models corresponding to different angles of the same gesture have been pre-stored as mentioned above, it is still possible that no matching predetermined hand skeleton model is found when the user has made a correct gesture operation, therefore, an error range for the matching can be set. If a difference between the current hand skeleton model and the predetermined hand skeleton model is within the error range, then the predetermined control instruction associated with said predetermined hand skeleton model can be determined as the control instruction corresponding to the current operation action.

In an embodiment of the present disclosure, the process of projecting and displaying the graphical interface including a plurality of image areas representing different electrical appliances may include: obtaining state information of the plurality of electrical appliances to be controlled, generating the graphical interface including a plurality of image areas representing different electrical appliances, so that the plurality of image areas in the generated graphical interface display the state information of the different electrical appliances, and projecting the generated graphical interface to a projection area. The state information may, for example, indicate whether the current operating state of the electrical appliance to be controlled is an ON state or an OFF state, the time for which the electrical appliance to be controlled is continuously used this time, the time for which the electrical appliance to be controlled is asleep, etc. The embodiment of the present disclosure enables the user to directly see the current operating state of each electrical appliance, so that the user can alter operation of some electrical appliances as desired so as to change the operation states thereof.

In another embodiment of the present disclosure, after sending the control instruction to the electrical appliance corresponding to the target image area in step S104, there may be an step of obtaining the altered operation state of the electrical appliance and updating the state information of said electrical appliance in the graphical interface. In the embodiment of the present disclosure, after making an operation action in the target image area, the user can directly see in real time the operation state change of the electrical appliance after executing the control instruction corresponding to the operation action, thus improving the interactive experience of the user.

The above embodiments are merely exemplary embodiments of the present disclosure, but they do not limit the present disclosure. The protection scope of the present disclosure is defined by the claims. Those skilled in the art can make various modifications or equivalent substitutions to the present disclosure within the substance and protection scope of the present disclosure, so such modifications or equivalent substitutions shall be considered as falling into the protection scope of the present disclosure.

1. A device for controlling electrical appliances, comprising:
a projector configured to project a graphical interface having a plurality of image areas representing different electrical appliances respectively;
a camera configured to obtain a first image including an operation action of a user on the graphical interface; and
a controller configured to determine a target image area and a control instruction corresponding to the operation action according to said first image and to send said control instruction to an electrical appliance corresponding to the target image area.

2. The device according to claim 1, wherein
the controller is further configured to obtain state information of the plurality of electrical appliances to be controlled and to generate the graphical interface according to the obtained state information, wherein each of the plurality of image areas displays the state information of the corresponding electrical appliance.

3. The device according to claim 2, wherein
the controller is further configured to, after sending said control instruction to the electrical appliance corresponding to the target image area, obtain an altered operation state of said electrical appliance and update the state information of said electrical appliance in the graphical interface.

4. The device according to claim 1, further comprising a housing configured to accommodate the projector, the camera, and the controller.

5. The device according to claim 4, further comprising a wireless transceiver disposed within the housing and configured to establish communication between the controller and the electrical appliance.

6. The device according to claim 1, further comprising a power interface through which the device is supplied with power.

7. The device according to claim 6, further comprising a power manager configured to manage the supply of power.

8. The device according to claim 1, wherein the operation action comprises at least one of a touch operation action and a non-touch operation action.

9. The device according to claim 1, wherein the controller is further configured to obtain characteristic information of each node of a hand of the user in the first image and determine an image area where a predetermined node of the user is located as the target image area.

10. The device according to claim 2, wherein the status information indicates the current operation state of the electrical appliance to be controlled.

11. A method for controlling electrical appliances, comprising:
projecting and displaying a graphical interface having a plurality of image areas representing different electrical appliances;
obtaining a first image including an operation action of a user on the graphical interface;
determining a target image area and a control instruction corresponding to the operation action according to said first image;
sending said control instruction to an electrical appliance corresponding to the target image area.

12. The method according to claim 11, wherein the operation action comprises at least one of a touch operation action and a non-touch operation action.

13. The method according to claim 11, wherein determining the target image area corresponding to the operation action according to the first image comprises:
obtaining characteristic information of each node of a hand of the user in the first image and determining an image area where a predetermined node of the user is located as the target image area.

14. The method according to claim 11, further comprises
pre-identifying nodes of a gesture corresponding to each control instruction from a plurality of predetermined control instructions and storing the identified nodes as a hand skeleton model associated with said control instruction so as to form a plurality of hand skeleton models;
determining a control instruction corresponding to the operation action according to the first image and the plurality of hand skeleton models stored.

15. The method according to claim 14, wherein determining the control instruction corresponding to the operation action according to the first image and the plurality of hand skeleton models stored comprises:
obtaining characteristic information of each node of a hand of the user in the first image and creating a current hand skeleton model according to the obtained characteristic information of each node;
matching said current hand skeleton model with the stored plurality of hand skeleton models;
in response to a difference between the current hand skeleton model and one of the stored plurality of hand skeleton models falling within a threshold range, determining the control instruction associated with said one hand skeleton model as the control instruction corresponding to the operation action.

16. The method according to claim 11, wherein projecting and displaying a graphical interface having a plurality of image areas representing different electrical appliances comprises:
obtaining state information of the plurality of electrical appliances to be controlled;
generating a graphical interface having a plurality of image areas representing different electrical appliances, wherein each of the plurality of image areas displays the state information of the corresponding electrical appliance;
projecting and displaying the graphical interface.

17. The method according to claim 11, further comprising:
after sending the control instruction to the electrical appliance corresponding to the target image area, obtaining an altered operation state of the electrical appliance and updating the state information of said electrical appliance in the graphical interface.

18. The method according to claim 16, wherein the status information indicates the current operation state of the electrical appliance to be controlled.

19. The method according to claim 12, wherein projecting and displaying a graphical interface having a plurality of image areas representing different electrical appliances comprises:
obtaining state information of the plurality of electrical appliances to be controlled;
generating a graphical interface having a plurality of image areas representing different electrical appliances, wherein each of the plurality of image areas displays the state information of the corresponding electrical appliance;
projecting and displaying the graphical interface.

20. The method according to claim 12, further comprising:
after sending the control instruction to the electrical appliance corresponding to the target image area, obtaining an altered operation state of the electrical appliance and updating the state information of said electrical appliance in the graphical interface.
